(19) United States
(12) Patent Application Publication
(10) Pub. No.: US 2026/0214313 A1
(43) Pub. Date: Jul. 23, 2026

(54) LENS MODULE AND TERMINAL DEVICE

(71) Applicant: TRIPLE WIN TECHNOLOGY(SHENZHEN) CO.LTD., Shenzhen (CN)

(72) Inventor: JIAN-ZONG LIU, New Taipei (TW)

(21) Appl. No.: 19/253,405

(22) Filed: Jun. 27, 2025

(30) Foreign Application Priority Data
Jan. 21, 2025 (CN) 202510092124.5

(51) Int. Cl. H04N 23/55; H04N 23/56

(52) U.S. Cl. CPC H04N 23/55; H04N 23/56

(57) ABSTRACT

A lens module includes a base, a shielding member, a light emitter, a receiving lens, and a photosensitive chip. The shielding member and the base are cooperatively form a first space and a second space. The shielding member defines a third space and a channel. The receiving lens is located in the second space. The shielding member covers the first photosensitive area of the photosensitive chip. The second photosensitive area of the photosensitive chip is located in the second space. The light emitter can emit a first light beam, causing the first light beam to pass through the channel and incident on the first photosensitive area. The light emitter further can emit a second light beam, causing the second light beam successively to pass through the first space, the receiving lens, and the second space, and incidents on the second photosensitive area. The present disclosure provides a terminal device.

### FIELD

The subject matter herein generally relates to lens, and more particularly, to a lens module and a terminal device.

### BACKGROUND

A lens module includes a base, a light emitter, and a receiving lens. The base includes a body and a blacking wall fixed to each other. The blacking wall divides the body into two distinct spaces, with the light emitter and the receiving lens located in the two spaces of the base. Due to the miniaturized structural design of the lens module, the flexibility of installing the base and other components in the lens module is reduced. Therefore, there is a room for improvement in the art.

### BRIEF DESCRIPTION OF THE DRAWINGS

Implementations of the present technology will now be described, by way of example only, with reference to the attached figures.

FIG. 1 is a diagrammatic view of a terminal device according to an embodiment of the present disclosure.

FIG. 2 is a diagrammatic view of a lens module of the terminal device shown in FIG. 1.

FIG. 3 is an exploded view of the lens module shown in FIG. 2.

FIG. 4 is similar to the FIG. 3, but showing the lens module viewed from another angle.

FIG. 5 is a cross-sectional view of the lens module shown in FIG. 2 along a view line A-A.

FIG. 6 is a cross-sectional view of the lens module shown in FIG. 2 along a view line B-B.

FIG. 7 is a diagrammatic view of a shielding member of the lens module.

FIG. 8 is an enlarged view of a region I shown in FIG. 6.

FIG. 9 is a cross-sectional view of the lens module according to another embodiment of the present disclosure.

FIG. 10 is a top diagrammatic view of a portion components of the lens module provided according to another embodiment of the present disclosure.

FIG. 11 is a diagrammatic view of a light reflection provided in some other embodiments.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

Some embodiments of the present disclosure will be described in detail with reference to the drawings. If no conflict, the following embodiments and features in the embodiments can be combined with each other.

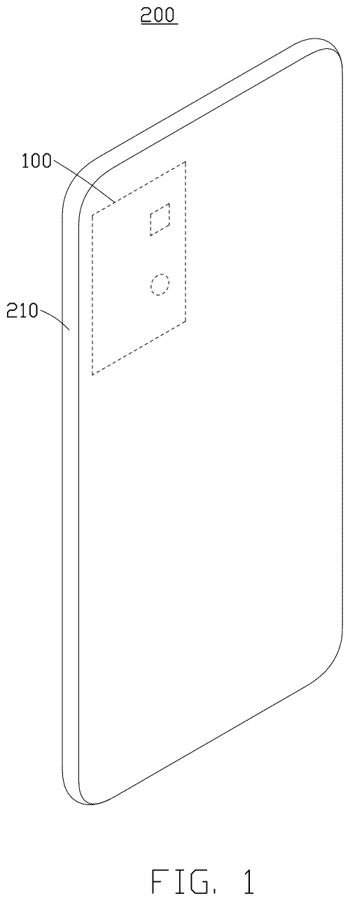

Referring to FIG. 1, a terminal device 200 is provided according to an embodiment of the present disclosure. The terminal device 200 may include a housing 210 and a lens module 100. The lens module 100 is accommodated in the housing 210. The terminal device 200 may include, but is not limited to, an electronic product with photography and/or video recording functions such as a mobile phone, a camera, a laptop, a drone, and a surveillance monitor. In the embodiment shown in FIG. 1, the terminal device 200 is a mobile phone.

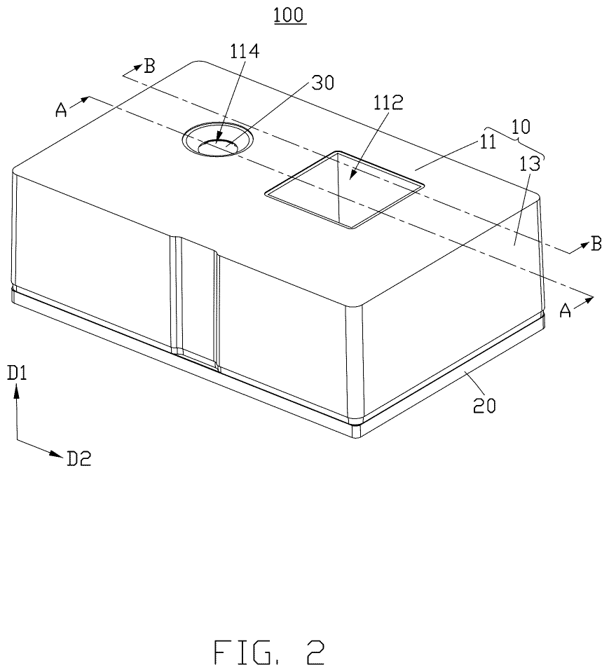

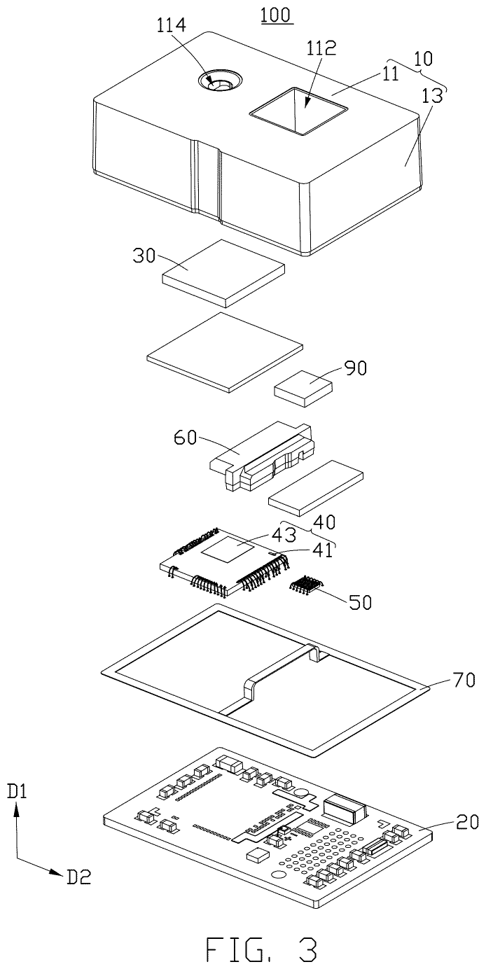

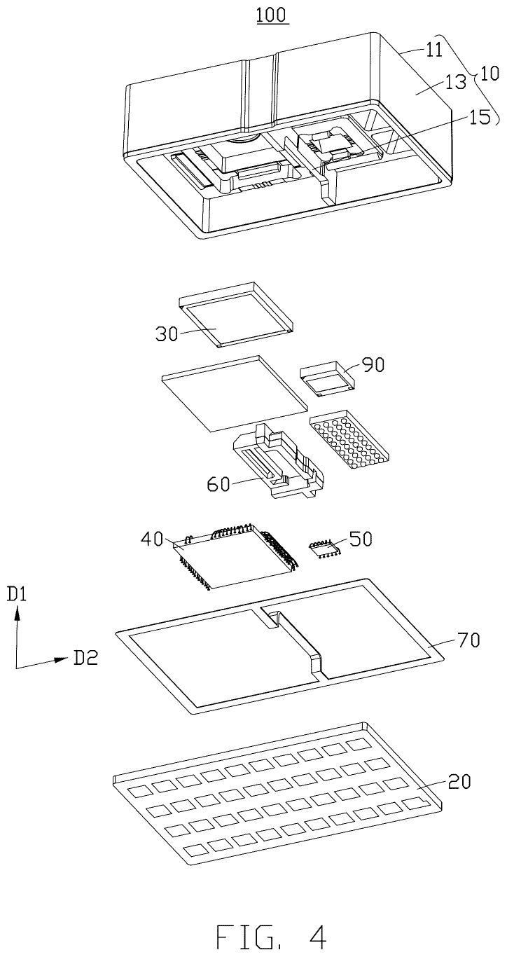

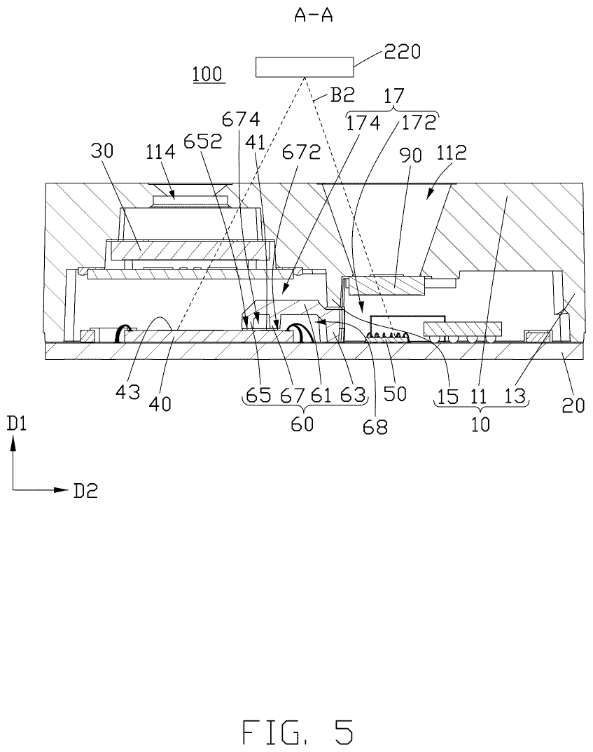

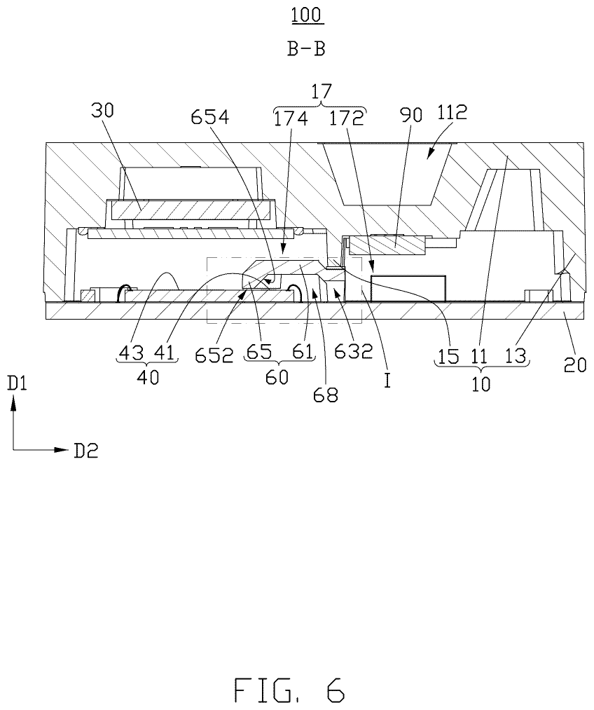

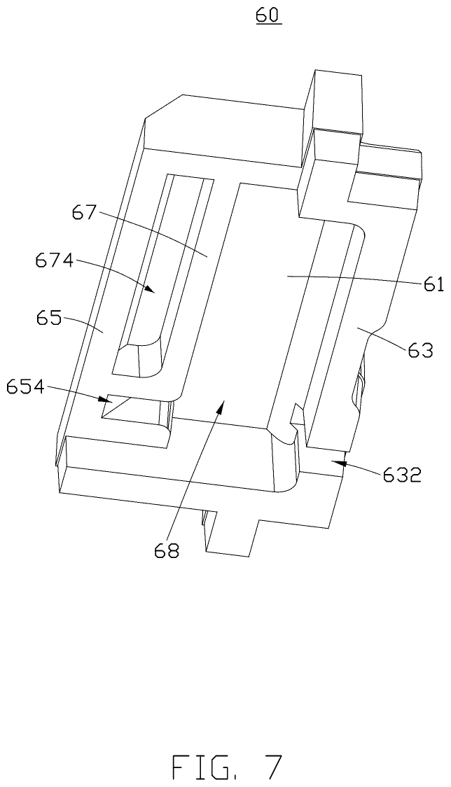

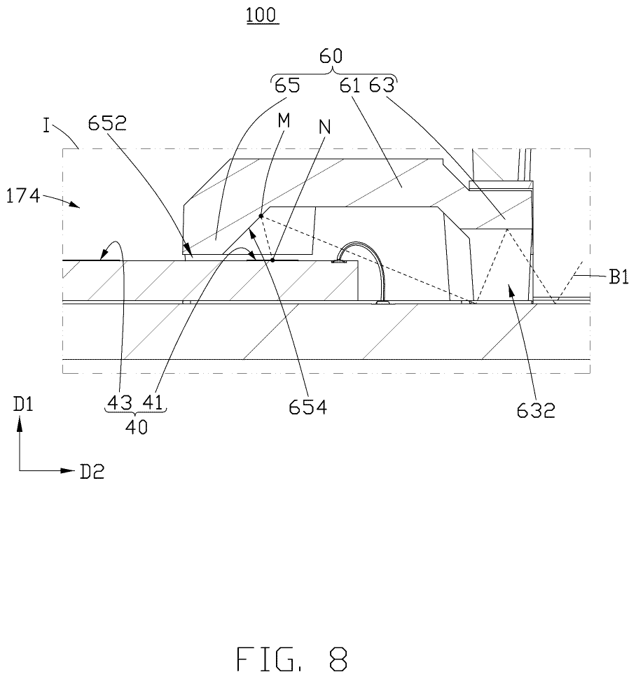

Referring to FIGS. 2 to 8, FIG. 2 is a diagrammatic view of the lens module 100 according to the embodiment. FIG. 3 is an exploded view of the lens module 100 shown in FIG. 2. FIG. 4 is an exploded view of the lens module 100 shown in FIG. 2 from another orientation. FIG. 5 is a cross-sectional view of the lens module 100 shown in FIG. 2 along a view line A-A. FIG. 6 is a cross-sectional view of the lens module 100 shown in FIG. 2 along a view line B-B. FIG. 7 is a diagrammatic view of a shielding member 60 of the lens module 100. FIG. 8 is an enlarged view of a region I shown in FIG. 6.

The lens module 100 may include a base 10, a receiving lens 30, a photosensitive chip 40, a light emitter 50, and a shielding member 60. The shielding member 60 and the base 10 cooperatively form a first space 172 and a second space 174. The shielding member 60 has a third space 68 and a channel 632. The channel 632 communicates with the first space 172 and the third space 68. The light emitter 50 is located in the first space 172 and can emit a first light beam B1 and a second light beam B2. The receiving lens 30 is located in the second space 174. The photosensitive chip 40 includes a first photosensitive area 41 and a second photosensitive area 43. The shielding member 60 covers the first photosensitive area 41. The first photosensitive area 41 is located in the third space 68. The second photosensitive area 43 is located in the second space 174. The first light beam B1 passes through the channel 632 and incidents on the first photosensitive area 41. The second light beam B2 passes through the first space 172 and then through the receiving lens 30 after being reflected, such that the second light beam B2 can further enter the second space 174 and incident on the second photosensitive area 43. The above embodiment can achieve the effect of reducing interference of the first light beam B1 with the second light beam B2 in the second space 174.

In the embodiment, more specifically, the base 10 has a hollow internal structure. The base 10 is provided with a light exit hole 112 and a light entrance hole 114. The light exit hole 112 and the light entrance hole 114 pass through the base 10 along a first direction D1.

In the embodiment, the base 10 is roughly in a cuboid structure. The base 10 includes a top plate 11 and side plates 13. The side plates 13 are located on the same side of the top plate 11 and surround the top plate 11. The light exit hole 112 and the light entrance hole 114 are defined on the top plate 11. The lens module 100 may further include a circuit board 20. The circuit board 20 is located on a side of the side plates 13 away from the top plate 11. The circuit board 20 and the base 10 cooperatively form a receiving space 17 (referring to FIG. 6). The first space 172 and the second space 174 are located in the receiving space 17. The receiving lens 30, the photosensitive chip 40, the light emitter 50, and the shielding member 60 are accommodated in the receiving space 17. The lens module 100 may further include an adhesive layer 70. The adhesive layer 70 bonds the side plates 13 of the base 10 to the circuit board 20, and further bonds the base 10 to the shielding member 60. In other embodiments, the base 10 is not limited to a cuboid structure. For example, the base 10 can also be a hollow cylinder.

The base 10 may further include an extending plate 15. The extending plate 15 extends from one side of the top plate 11 toward the circuit board 20, with the shielding member 60 being located between the extending plate 15 and the circuit board 20. The circuit board 20, the base 10, and the shielding member 60 cooperatively form the first space 172 and the second space 174. The first space 172 and the second space 174 are located in the receiving space 17. The extending plate 15 is connected to the shielding member 60. The extending plate 15 and the shielding member 60 are located between the first space 172 and second space 174. The first space 172 communicates with the light exit hole 112. The light emitter 50 is located in the first space 172. The second space 174 communicates with the light entrance hole 114. The receiving lens 30 is located in the second space 174. The light emitter 50 and the photosensitive chip 40 are electrically connected to the circuit board 20.

The light entrance hole 114 covers the receiving lens 30 along the first direction D1. The receiving lens 30 includes a meta-lens. The meta-lens has characteristics of features high precision, multi-functionality, and broad bandwidth. The receiving lens 30 can flexibly manipulate and efficiently focus light by precisely controlling light wave properties such as phase, amplitude, and polarization. The receiving lens 30 is thin, which can reduce a thickness of the lens module 100 along the first direction D1, and is beneficial to reduce the overall volume of the lens module 100.

The photosensitive chip 40 includes a first photosensitive area 41 and a second photosensitive area 43. The first photosensitive area 41 and the second photosensitive area 43 are disposed along a second direction D2. The first photosensitive area 41 and the second photosensitive area 43 are spaced apart from each other. The first photosensitive area 41 is located on a side of the second photosensitive area 43 closer to the light emitter 50. The second photosensitive area 43 is located in the second space 174.

The shielding member 60 covers the first photosensitive area 41. The first photosensitive area 41 is located in the third space 68. The second photosensitive area 43 is exposed from the shielding member 60. The shielding member 60 is either an opaque member or has a light-absorbing coating. The shielding member 60 can reduce the amount of the first light beam B1 emitted from the light emitter 50 to the first photosensitive area 41 and prevent interference of the first light beam B1 with the second light beam B2 reflected to the second photosensitive area 43.

The light emitter 50 can emit the first light beam B1 (referring to FIG. 8) and the second light beam B2 (referring to FIG. 5). The first light beam B1 passes through the first space 171 and the channel 632 and then incidents on the first photosensitive area 41. The second light beam B2 passes through the first space 172 and then through the receiving lens 30 after being reflected, such that the second light beam B2 can enter the second space 174 and incident on the second photosensitive area 43. The first photosensitive area 41 is used to receive the first light beam B1 as a time reference. The first photosensitive area 41 serves as a sub-array pixel of the photosensitive chip 40. The second photosensitive area 43 is used to receive the second light beam B2 reflected from an object 220. The second photosensitive area 43 serves as a main pixel of the photosensitive chip 40.

The receiving lens 30 covers a portion of the shielding member 60 in the first direction D1. A gap is defined between the shielding member 60 and the receiving lens 30. That is, there will be no positional interference between the shielding member 60 and the receiving lens 30, which can reduce the size of the lens module 100 along the second direction D2, thus can reduce the overall volume of the lens module 100.

Referring to FIG. 7 and FIG. 8, the shielding member 60 may include a cover plate 61, a first baffle 63, and a second baffle 65. Both of the first baffle 63 and the second baffle 65 are located on the same side of the cover plate 61 facing the circuit board 20. The cover plate 61, the first baffle 63, and the second baffle 65 cooperatively form a third space 68. The first baffle 63 is disposed on the circuit board 20. The second baffle 65 is located on the photosensitive chip 40. A first gap 652 is defined between the second baffle 65 and the photosensitive chip 40 along the first direction D1. When the lens module 100 is subjected to impaction or dropped, the first gap 652 can prevent a stress of the shielding member 60 from being transmitted to the photosensitive chip 40, thereby reducing the damages to the photosensitive chip 40.

The channel 632 is defined on a side of the first baffle 63 close to the light emitter 50. The first light beam B1 emitted by the light emitter 50 can pass through the channel 632. The shielding member 60 further includes an inclined surface 654. The inclined surface 654 is located on a side wall of the second baffle 65 facing the channel 632. The inclined surface 654 intersects with the first direction D1 and the second direction D2. The inclined surface 654 can reflect the first light beam B1, which enter the third space 68 through the channel 632, to the first photosensitive area 41.

The first light beam B1 emitted by the light emitter 50 passes through the channel 632 and irradiates the inclined surface 654. The inclined surface 654 reflects the first light beam B1 to the first photosensitive area 41. The second light beam B2 emitted by the light emitter 50 passes through the first space 172 and the light exit hole 112 and irradiates the object 220. The object 220 reflects the second light beam B2. The reflected second light beam B2 passes through the light entrance hole 114 and the receiving lens 30, enters the second space 174, and incidents on the second photosensitive area 43.

Referring to FIG. 8, a point where the first light beam B1 irradiates the inclined surface 654 is defined as a reflection point M, and a point where the first light beam B1 is reflected by the inclined surface 654 to the first photosensitive area 41 is defined as a receiving point N. In some embodiments, a projection of the reflection point M on the photosensitive chip 40 (i.e., the orthogonal projection along the first direction D1) is between the receiving point N and the second photosensitive area 43, which can prevent the first light beam B1 reflected to the first photosensitive area 41 from passing through the first gap 652 and then interfered with the second light beam B2 reflected to the second photosensitive area 43.

The shielding member 60 may further include a third baffle 67. The third baffle 67 is located on a side of the cover plate 61 and between the first baffle 63 and the second baffle 65. The cover plate 61, the third baffle 67, and the second baffle 65 cooperatively form a reflection groove 674. Due to the reflection groove 674, when the first light beam B1 enters the reflection groove 674, the first light beam B1 is difficult to exit the reflection groove 674 and interfere with other light beams.

A third gap 672 is defined between the third baffle 67 and the photosensitive chip 40 along the first direction D1. When the lens module 100 is subjected to impact or dropped, the third gap 672 can prevent the stress of the shielding member 60 from being transmitted to the photosensitive chip 40, thereby reducing the damages to the photosensitive chip 40.

The lens module 100 may further include a transmitting lens 90. The transmitting lens 90 can also be meta-lens. The transmitting lens 90 is located in the first space 172. The transmitting lens 90 covers the light exit hole 112 along the first direction D1. The second light beam B2 emitted by the light emitter 50 successively to pass through the first space 172, the transmitting lens 90, and the light exit hole 112 and irradiates the object 220.

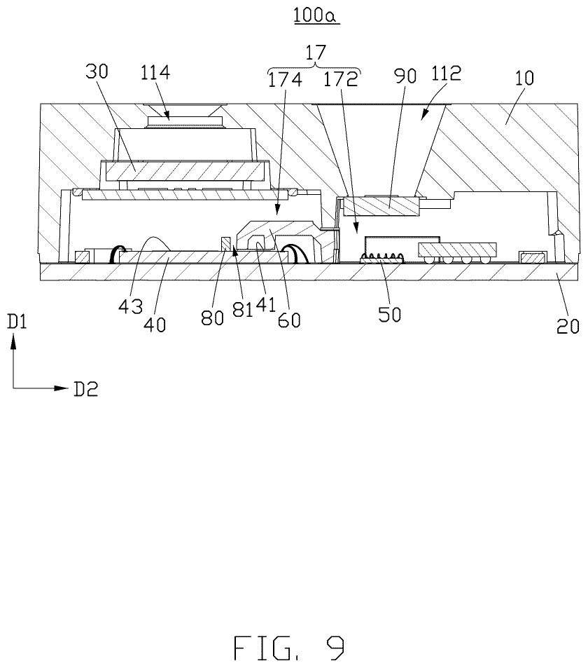

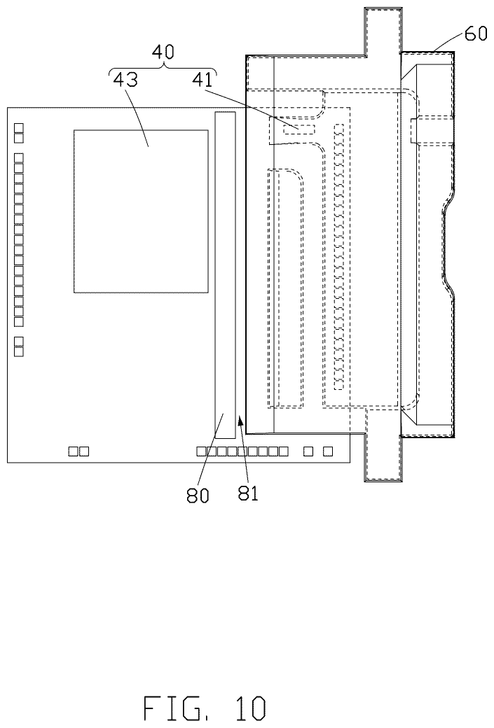

Referring to FIGS. 9 to 11, a lens module 100a is provided according to another embodiment of the present disclosure. Different from the above lens module 100, the lens module 100a may further include a light shielding adhesive 80. The light shielding adhesive 80 is disposed on the photosensitive chip 40 and between the shielding member 60 and the second photosensitive area 43. A second gap 81 is defined between the light shielding adhesive 80 and the shielding member 60 along the first direction D1. That is, the light shielding adhesive 80 and the shielding member 60 are not directly connected to each other. The shielding member 60 will not transmit stress to the photosensitive chip 40 through the light shielding adhesive 80.

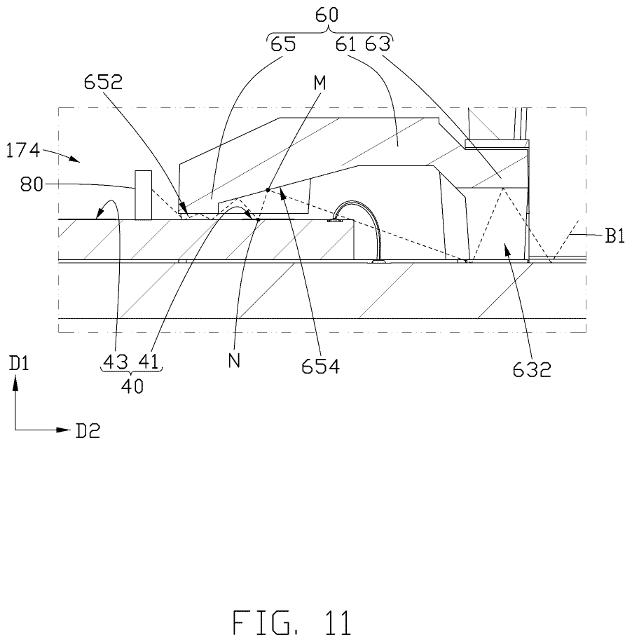

Referring to FIG. 11, the light shielding adhesive 80 can block the first light beam B1 passing through the first gap 652 to reduce the interference of the first light beam B1 with the second light beam B2 in the second space 174. The light shielding adhesive 80 can also have a light absorption function to prevent the second light beam B2 from being reflected back to the second space 174 through the light shielding adhesive 80.

According to the lens module 100 provided in the embodiments, the base 10 and the shielding member 60 are two independent components, which can improve the installation flexibility of the lens module 100. In addition, on the premise that the shielding member 60 can prevent the first light beam B1 from interfering with the second light beam B2 in the second space 174, the shielding member 60 will not have positional interference with the receiving lens 30, which is beneficial to reducing the size of the lens module 100 along the second direction D2, thereby reducing the overall volume of the lens module 100.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lens module comprising:
a base;
a shielding member, the shielding member and the base cooperatively forming a first space and a second space, the shielding member defining a third space and a channel communicating with the first space and the third space;
a light emitter located in the first space;
a receiving lens located in the second space; and
a photosensitive chip comprising a first photosensitive area and a second photosensitive area, the shielding member covering the first photosensitive area, the first photosensitive area located in the third space, and the second photosensitive area located in the second space,
wherein the light emitter is configured to emit a first light beam, causing the first light beam to pass through the channel and incident on the first photosensitive area; the light emitter is further configured to emit a second light beam, causing the second light beam successively to pass through the first space, the receiving lens, and the second space, and incidents on the second photosensitive area.

2. The lens module of claim 1, wherein the shielding member comprises an inclined surface, the inclined surface is configured to receive the first light beam passing through the channel, and the inclined surface is further configured to reflect the first light beam to the first photosensitive area.

3. The lens module of claim 2, further comprising a shielding adhesive, wherein the shielding adhesive is disposed on the photosensitive chip and located between the shielding member and the second photosensitive area, the shielding member and the photosensitive chip cooperatively form a first gap, and the shielding adhesive is configured to block the first light beam passing through the first gap.

4. The lens module of claim 3, wherein the shielding adhesive and the shielding member cooperatively form a second gap.

5. The lens module of claim 3, further comprising a circuit board, wherein each of the shielding member, the light emitter, and the photosensitive chip is located on the circuit board.

6. The lens module of claim 5, wherein the shielding member comprises a cover plate, a first baffle, and a second baffle, the first baffle and the second baffle are located on the same side of the cover plate facing the circuit board, the cover plate, the first baffle, and the second baffle cooperatively form the third space, the first baffle is disposed on the circuit board, the second baffle is located on the photosensitive chip, and the second baffle and the photosensitive chip cooperatively form the first gap.

7. The lens module of claim 6, wherein the shielding member further comprises a third baffle, the third baffle is located between the first baffle and the second baffle, the third baffle and the photosensitive chip cooperatively form a third gap, wherein the third baffle, the cover plate, and the second baffle cooperatively form a reflection groove.

8. The lens module of claim 5, wherein the base comprises a top plate and side plates, the side plates surround the top plate, the circuit board is located on a side of the side plates away from the top plate, wherein the circuit board, the shielding member, and the base cooperatively form the first space and the second space.

9. The lens module of claim 8, wherein the base further comprises an extending plate, the extending plate extends from one side of the top plate towards the circuit board, the shielding member is located between the extending plate and the circuit board, and the shielding member and the extending plate are located between the first space and the second space.

10. The lens module of claim 5, wherein the lens module further comprises an adhesive layer, the adhesive layer bonds the base to the circuit board, and the adhesive layer further bonds the base to the shielding member.

11. The lens module of claim 1, wherein the receiving lens covers a portion of the shielding member.

12. The lens module of claim 1, wherein the receiving lens comprises a meta-lens.

13. A terminal device comprising a lens module, the lens module comprising:
a base;
a shielding member, the shielding member and the base cooperatively forming a first space and a second space, the shielding member defining a third space and a channel communicating with the first space and the third space;
a light emitter located in the first space;
a receiving lens located in the second space; and
a photosensitive chip comprising a first photosensitive area and a second photosensitive area, the shielding member covering the first photosensitive area, the first photosensitive area located in the third space, and the second photosensitive area located in the second space;
wherein the light emitter is configured to emit a first light beam, causing the first light beam to pass through the channel and incident on the first photosensitive area; the light emitter is further configured to emit a second light beam, causing the second light beam successively to pass through the first space, the receiving lens, and the second space, and incidents on the second photosensitive area.

14. The terminal device of claim 13, wherein the shielding member comprises an inclined surface, the inclined surface is configured to receive the first light beam passing through the channel, and the inclined surface is further configured to reflect the first light beam to the first photosensitive area.

15. The terminal device of claim 14, wherein the terminal device further comprises a shielding adhesive, wherein the shielding adhesive is disposed on the photosensitive chip and located between the shielding member and the second photosensitive area, the shielding member and the photosensitive chip cooperatively form a first gap, and the shielding adhesive is configured to block the first light beam passing through the first gap.

16. The terminal device of claim 15, wherein the shielding adhesive and the shielding member cooperatively form a second gap.

17. The terminal device of claim 15, wherein the terminal device further comprises a circuit board, wherein each of the shielding member, the light emitter, and the photosensitive chip is located on the circuit board.

18. The terminal device of claim 17, wherein the shielding member comprises a cover plate, a first baffle, and a second baffle, the first baffle and the second baffle are located on the same side of the cover plate facing the circuit board, the cover plate, the first baffle, and the second baffle cooperatively form the third space, the first baffle is disposed on the circuit board, the second baffle is located on the photosensitive chip, and the second baffle and the photosensitive chip cooperatively form the first gap.

19. The terminal device of claim 18, wherein the shielding member further comprises a third baffle, the third baffle is located between the first baffle and the second baffle, the third baffle and the photosensitive chip cooperatively form a third gap, wherein the third baffle, the cover plate, and the second baffle cooperatively form a reflection groove.

20. The terminal device of claim 17, wherein the base comprises a top plate and side plates, the side plates surround the top plate, the circuit board is located on a side of the side plates away from the top plate, wherein the circuit board, the shielding member, and the base cooperatively form the first space and the second space.
